(19) United States
(12) Patent Application Publication
(10) Pub. No.: US 2008/0005918 A1
(43) Pub. Date: Jan. 10, 2008

(54) APPARATUS FOR DRYING FOODSTUFFS

(75) Inventor: Antonio Turatti, Cavarzere (IT)

Correspondence Address: GAUTHIER & CONNORS, LLP, 225 FRANKLIN STREET, SUITE 2300, BOSTON, MA, 02110, US

(73) Assignee: TURATTI S.r.l., Cavarzere (IT)

(21) Appl. No.: 11/695,740

(22) Filed: Apr. 3, 2007

(30) Foreign Application Priority Data
Apr. 12, 2006 (IT) RM2006A000211
Jan. 23, 2006 (IT) RM2006A000027

(51) Int. Cl. F26B 17/30

(52) U.S. Cl. 34/58

(57) ABSTRACT

The invention relates to an improved apparatus (1) for drying food-stuffs, comprising at least a centrifugation basket (5) for drying said product by its rotation, the lateral surface of said basket (5) being holed; a pin (13) rotating coupled with said at least a centrifugation basket (5); and a motor (12), mechanically coupled with said rotation pin (13); said apparatus (1) being characterised in that said motor (12) is a synchronous three-phase electric motor (12) and in that it comprises means (16) for controlling rotation of said motor (12) for adjusting the torque output by said motor (12) with respect to its rotation speed.

The present invention relates to an improved apparatus for drying foodstuffs.

More specifically, the invention relates to an apparatus of the above kind, particularly studied and realised for removing humidity from leaf products, permitting optimised power consumption for every situation.

As it is well known, many apparatuses or machines exist for drying leaf products, such as vegetables or fruit, or for removing water from the same. Particularly, different kind of said apparatuses or machines exist exploiting centrifugal force for removing said residual humidity.

Above mentioned machines are usually comprised of a rotating basket, with vertical or horizontal axis, containing the product to be dried. Said basket is driven by an electric, hydraulic or pneumatic motor. Drying cycle is a batch cycle, providing a basket loading step, a centrifugation step and a product discharge step.

Rotation speed and working time can be usually adjusted. Some of these machines are loaded and unloaded on the same side and thus mechanisms for upturning the same are provided. Other machines are loaded and unloaded from opposite ends.

Known machines providing electric motors usually use asynchronous three-phase motors. Said motors overheat at low speed due to their design criteria, i.e. during the loading and unloading steps, and, moreover, they have a peak of power absorption at the start, thus when beginning the centrifugation, with a very low torque generated.

In view of the above, known electric centrifugal apparatuses must provide oversized motors, with cooling device for operation at low speed. This increases their dimensions, thus making the same not convenient.

Furthermore, asynchronous three-phase motors must provided transmission pulleys for reduction of number of revolution, as well as electronic speed regulators (inverter), the adjustment range of which is in any case very limited (ratio between about 1 and about 3).

As far as centrifugal machines or apparatuses driven by hydraulic motors, it is known that they can have an even torque with low regime, but that they are huge, being activated by suitable stations. Therefore, they are more Complex to be realised and assembled but, particularly, in case of oil leakages, they can contaminate the product.

In view of the above it is object of the present invention that of providing an apparatus for removing surface humidity of different products by centrifugal force, having high capacity, reduced dimensions and driven by an electric motor.

Another object of the invention is that of providing an apparatus outputting a uniform torque with low regime.

It is therefore specific object of the present invention an improved apparatus for drying foodstuffs, comprising at least a centrifugation basket for drying said product by its rotation, the lateral surface of which is holed; a pin rotating coupled with said at least a centrifugation basket; and a motor, mechanically coupled with said rotation pin; said apparatus being characterised in that said motor is a asynchronous three-phase electric motor and in that it comprises means for controlling rotation of said motor for adjusting the torque output by said motor with respect to its rotation speed.

Always according to the invention, said control means can comprise an encoder for detection of the rotation speed or of the position of said motor.

Still according to the invention, said control means can comprise a feedback control device connected with said encoder for adjusting supply and/or power output to said motor on the basis of the value of the motor speed detected by said encoder.

Preferably, according to the invention, said apparatus can comprise a support housing, within which said at least a centrifugation basket is placed, rotating coupled with the same housing, said housing collecting liquid due to drying said product exiting through the holes on the lateral surface of said rotating centrifugation basket, said housing and said centrifugation basket realising a centrifugation assembly; at least an axis fixed to said housing; motion means mechanically coupled with said at least an axis, said motion means permitting rotation of said centrifugation basket with respect to its axis, in order to bring the same in the loading and unloading positions.

Furthermore, according to the invention, said motor can be placed between said housing and said centrifugation basket by a joint, said joint being fixed to said housing and rotating coupled with said rotation pin.

Always according to the invention, said motion means can comprise a motor, preferably an electric motor.

Preferably, according to the invention, said at least one axis can be a substantially horizontal axis.

Still according to the invention, said housing can comprise at least a discharge for outflow of said liquid arriving from the product drying.

Preferably, according to the invention, said improved apparatus can comprise means for discharging the dried product, such as a conveyor belt.

Still according to the invention, said improved apparatus can comprise a structure for supporting said centrifugation assembly.

The present invention will be now described, for illustrative but not limitative purposes, according to its preferred embodiments, with particular reference to the figures of the enclosed drawings, wherein:

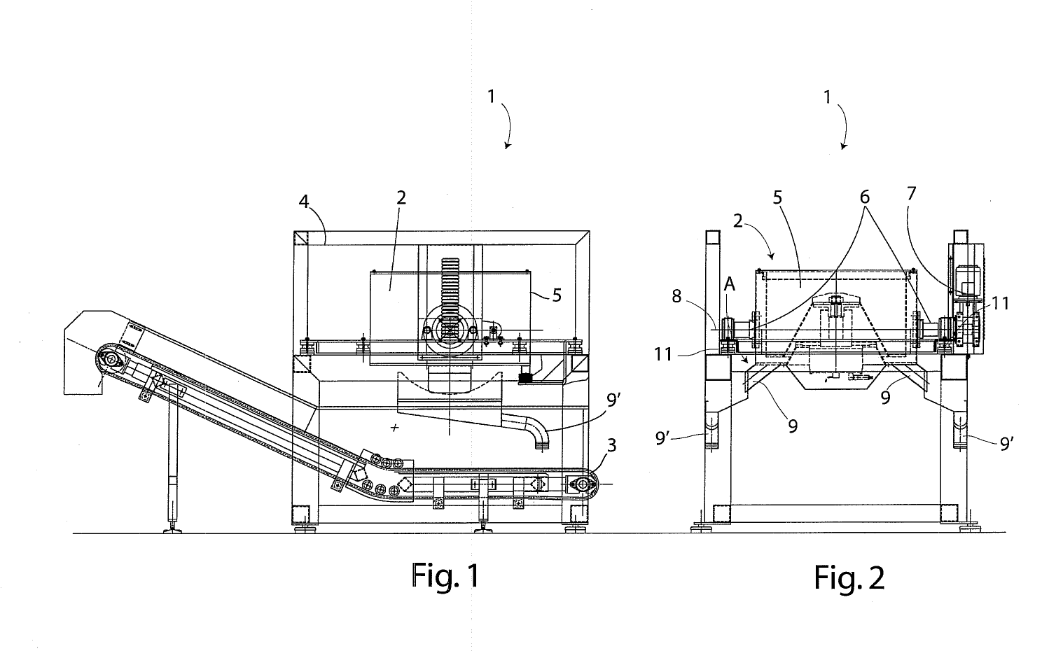

FIG. 1 shows a lateral view of drying apparatus for foodstuffs, particularly leaf products according to the present invention;

FIG. 2 shows a section front view of apparatus according to FIG. 1; and

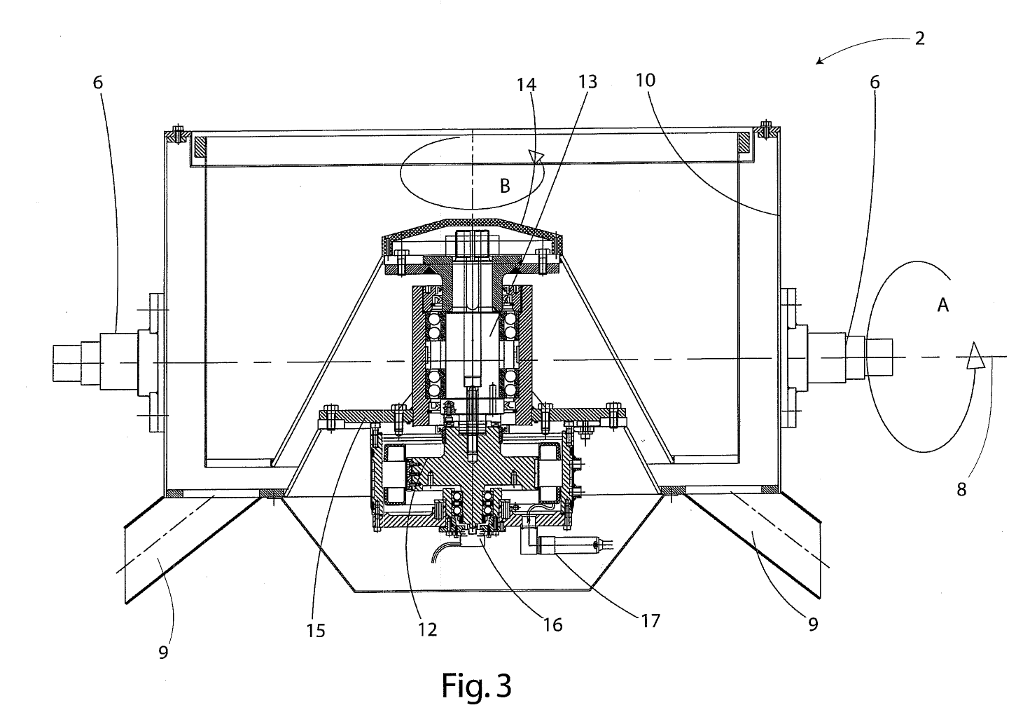

FIG. 3 shows a lateral section view of the drying group of apparatus according to FIG. 1.

Making reference to FIGS. 1 and 2 of the enclosed drawings, it is possible observing apparatus 1 for drying leaf products according to the invention.

Said apparatus 1 comprises a drying assembly 2, under which a product removal conveyor belt 3 is provided.

Said drying assembly is mounted on a support structure 4. It comprises a rotating centrifugation basket 5, mounted on substantially horizontal pins 6. Said pins 6 permit rotation of said centrifugation basket 5 according to direction A.

Said pins 6 permits to the centrifugation basket rotation about axis 8 during the unloading of the dried product by a motor 7.

Centrifugation basket 5 is holed on its surface (holes cannot be seen in the figures).

Discharge outlets 9 are provided under said centrifugation basket 5, connected with discharge cups, for outlet of water extracted from products during centrifugation.

Making now reference to FIG. 3, it can be noted that centrifugation basket 5 is placed within a hosing housing 10, coupled with said pins 6, resting on supports 11.

Within inner volume of said centrifugation basket 5, between the same basket and said housing 10, it is provided a synchronous centrifugation electric motor 12, for rotating the centrifugation basket according to direction B with respect to its symmetry axis.

Centrifugation basket 5 is connected with a rotation pin 13 by the upper part of a rotating joint 14. Outer part 15 of said rotating joint 14 is fixed on housing 10 along with motor 12. The whole drying assembly 2 can rotate about said horizontal axis 8 and about said pins 6.

Motor 12 is provided with an encoder 16 for controlling the position of the same motor 12, a power supply cable 17 and elements 18 for water cooling.

During the loading and centrifugation steps, said centrifugation basket 5 has its opening upward. When the centrifugation step is terminated, centrifugation basket upturns, rotating about axis 8 by said motor 7 acting on said pins 6, discharging the centrifuged product on the product removal conveyor belt 3.

Said centrifuged product is sent to the following workings by said product removal conveyor belt 3.

During the centrifugation step of the product contained within the centrifugation basket 5, carried out by said motor 12, water extracted from the product passes through the holes of the same centrifugation basket 5, collects within the housing 10 and outflows by outlets 9 and cups 9′.

Motor 12 is of the asynchronous three-phase type. It usually is used for high precision tools and in all those cases requiring a high torque at low regime along with a high precision of movements.

Encoder 17, permitting proper operation of said motor 12, is an electronic device. It permits detecting speed of rotating members, in this case synchronous three-phase motor 12, reading its position.

Said encoder 16 can be of many kinds. Opto-electronic encoders are widely used, permitting, by excitation of photo-diodes, detecting speed of a rotating member.

Encoder 16 is connected to a retroaction control circuit (not shown in the figures), connected to supply of said motor 12. particularly, once detected speed by said encoder 16, control circuit adjust power output to said motor 12, thus optimising torque output by the same. Particularly, it is possible obtaining keeping a constant torque of said motor 12 within a wide speed range (in the described embodiment between about 0 and 1000 rpm).

This kind of motors has a further positive feature. In the water cooled type, it has reduced dimensions, so as to be directly placed on the rotating pin 13 of the centrifugation basket.

These positive features, combined with a good design, permit realising a device with high capacity, high precision, reliability and reduced dimensions.

On the basis of the above specification, it can be noted that basic feature of the present invention is that of using a synchronous three-phase motor in a drying apparatus, employing a retroaction control device permitting maintaining a constant torque in a very wide speed range.

An advantage of the present invention is due to the reduced dimensions of the apparatus.

The present invention has been described for illustrative but not limitative purposes, according to its preferred embodiments, but it is to be understood that modifications and/or changes can be introduced by those skilled in the art without departing from the relevant scope as defined in the enclosed claims.

1. An apparatus for drying leaf products substantially comprised of a product supply or loading section, of a product centrifugation and drying section and of a dried product discharging section, operatively serially provided each other, wherein
the loading section comprises a conveyor belt for continuously supplying the entering product P, operated by a motor and a hopper, normally closed at the bottom for collecting the product supplied by the conveyor belt and then discharging the collected product on the drying section,
the centrifugation and drying section, downward the collection hopper of the supply section comprises a continuous conveyor with two parallel chains on which a plurality of centrifugation baskets is mounted, each one rotating about its own axis, said transport chains being provided along a closed loop path defining an onward run and a return run, said transport chains being moved by toothed wheels actuated by a motor, as well as by means for conferring to said centrifugation baskets a fast rotary motion about their own axis,
the discharge section, receiving the dried product from the centrifugation section, and transferring the same at the exit, comprises an elevator conveyor belt operated by a motor.

2. The apparatus according to claim 1, wherein said centrifugation baskets have their lateral surface provided with holes.

3. The apparatus according to claim 1, wherein said centrifugation baskets are fixed at the bottom at a shaft at the lower end of which a pulley is fixed, and said shaft in inserted and supported in such a way to freely rotate by suitable bearings, within a ring, fixed to transverse elements, which are bridging provided between said parallel transport chains.

4. The apparatus according to claim 1, wherein said means for conferring to said centrifugation baskets a fast rotary motion about their own axis comprises a pair of belts, realizing a closed loop about two pulleys, provided side-by-side and rotating according to the same direction by two further belts, operated by two motors rotating according to the same direction.

5. The apparatus according to claim 1, wherein rings of the belts are side-by-side and have a very lengthened shape, inner part of the chains are faced each other, parallel, and slide in the opposite direction.

6. The apparatus according to claim 1, wherein a tunnel is provided about part of the onward run of said transport chain supporting said centrifugation baskets, the inner walls of said tunnel collecting water ejected from the holes of said centrifugation baskets and to convey the same toward suitable lateral drainage.

7. The apparatus according to claim 3, wherein distance between opposed surfaces of the belts exactly correspond to the diameter of pulley fixed at the lower end of the shaft supporting the baskets, and said belts are so placed that, when each centrifugation basket, dragged by said chains, passes within said tunnel, said pulley enters within the space between the opposed surfaces of said belts and engages dragging the same.

8. The apparatus according to claim 1, wherein said conveyor belt is slidably mounted on the fixed frame and it is provided with a cyclic motion system comprising a motor and of a horizontal reciprocating motion transmission system to transform the rotatory motion of the motor into reciprocating motion of said conveyor belt.

9. The apparatus according to claim 8, wherein said conveyor belt is mounted on fixed frame by two parallel rods, pivoted about pins between the fixed frame and the conveyor belt, so as to realise an articulated parallelogram structure permitting to the conveyor belt moving with respect to the fixed frame and horizontally sliding with a reciprocating motion according to the product advancement direction and to the opposite one, respectively.

10. The apparatus according to claim 8, wherein horizontal reciprocating motion is obtained by an eccentric, powered by a motor through a belt, rotation of said eccentric is transmitted by a connecting rod directly to one of the rods of the articulated parallelogram.

11. The apparatus according to claim 1, wherein said apparatus comprises one or more pushing means acting on said motion transmission means so as to exert tension, thus increasing mechanical coupling force.

12. The apparatus according to claim 1, wherein said apparatus comprises water jets for cleaning said centrifugation baskets, provided under the apparatus before the end of the return run.

13. The apparatus according to claim 1, wherein it comprises a fan for drying and cleaning said centrifugation baskets provided before the beginning of their onward run.
